(19) United States
(12) Patent Application Publication
(10) Pub. No.: US 2012/0133776 A1
(43) Pub. Date: May 31, 2012

(54) LOW CONTRAST MIDWAVE FLIR IMPLEMENTATION

(75) Inventors: Todd Cicchi, Los Alamos, CA (US); Eric Woodbury, Santa Barbara, CA (US); Mark Alan Massie, Santa Ynez, CA (US)

(73) Assignee: NOVA RESEARCH, INC., Solvang, CA (US)

(21) Appl. No.: 13/032,819

(22) Filed: Feb. 23, 2011

Related U.S. Application Data
(60) Provisional application No. 61/307,787, filed on Feb. 24, 2010.

(51) Int. Cl. H04N 5/33

(52) U.S. Cl. 348/164; 348/E05.09

(57) ABSTRACT

An infrared camera system for low contrast employs a focal plane array (FPA) of a plurality of detector diodes. A read out integrated circuit (ROIC) including a plurality of integration switches is connected to the plurality of detector diodes. A frame mean calculator receives raw data from the FPA and an integration time servo receives a frame mean from the frame mean calculator and a preprogrammed target mean. The integration time servo compares the frame mean and target mean and provides an integration time output to the ROIC responsive to the comparison for control of the integration switches.

### REFERENCE TO RELATED APPLICATIONS

This application claims the priority of U.S. Provisional Patent Application Ser. No. 61/307,787 filed on Feb. 24, 2010 by inventors Todd Cicchi, Eric Woodbury and Mark Alan Massie entitled LOW CONTRAST MIDWAVE FLIR IMPLEMENTATION, the disclosure of which is referenced herein as though fully set forth.

### BACKGROUND INFORMATION

1. Field

Embodiments of the disclosure relate generally to the field of Forward Looking Infrared (FLIR) imaging systems and more particularly to embodiments for providing dynamic control of the integration time (Tint) of the focal plane array for enhanced cold background (low flux) imaging conditions.

2. Background

FLIR imaging systems are being employed in various operational systems for aviation and other uses. FLIR imaging systems are currently fielded in thousands of aircraft-borne systems. It has been determined that conventional indium antimonide (InSb) forward-looking infrared systems suffer from degraded noise performance when viewing cold background (low flux) conditions. Comments from actual pilots indicate that they believe the performance of such sensors to be degraded to the point where using conventional FLIR imaging systems in such conditions could pose significant safety issues. Not being able to see a “low contrast” obstacle when landing in cold, low relative flux conditions could cause aircraft damage and even pilot deaths.

It is therefore desirable to provide FLIR imagers which actively compensate for low flux conditions.

### SUMMARY

Exemplary embodiments provide an infrared camera system which employs a focal plane array (FPA) of a plurality of detector diodes. A read out integrated circuit (ROIC) including a plurality of integration switches is connected to the plurality of detector diodes. A frame mean calculator receives raw data from the FPA and an integration time servo receives a frame mean from the frame mean calculator and a preprogrammed target mean. The integration time servo compares the frame mean and target mean and provides an integration time output to the ROIC responsive to the comparison for control of the integration switches.

The features, functions, and advantages that have been discussed can be achieved independently in various embodiments of the present invention or may be combined in yet other embodiments further details of which can be seen with reference to the following description and drawings

### BRIEF DESCRIPTION OF THE DRAWINGS

FIG. 1 is a block diagram of an embodiment of integration time servoing for image detector control;

FIG. 2 is a block diagram of the non-uniformity and bad pixel correction elements employed within the embodiment;

FIG. 3 is a graphical comparison of servoed time integration and standard fixed time integration for FPA control; and,

FIG. 4 is a schematic of a unit cell of the FPA and ROIC.

### DETAILED DESCRIPTION

The embodiments described herein demonstrate camera systems that dynamically control the integration time (Tint) for Focal Plane Array (FPA) sensors such that the “integration charge well” always operates in an approximately 80% filled condition in a user programmable fashion. These systems produce measurably significant improvements in sensor signal-to-noise ratio (SNR) performance. Regardless of background temperature conditions, by continually adjusting the Tint, the average temporal SNR of pixel channels is lower than for prior art systems using a fixed Tint (usually chosen in the factory or set at a constant default value based on room temperature background conditions).

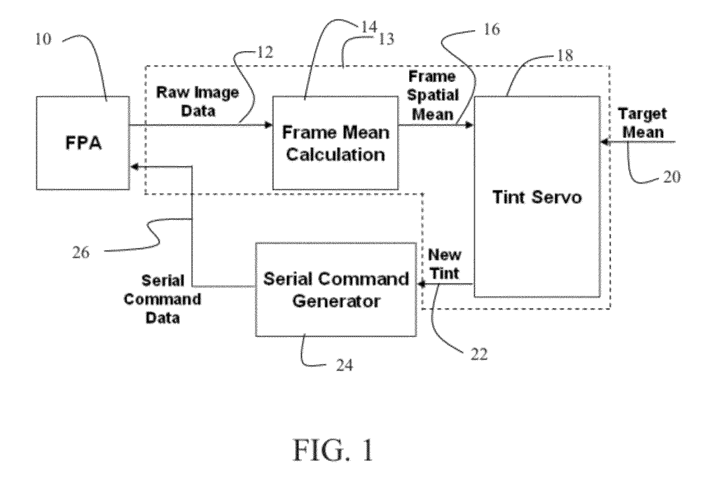

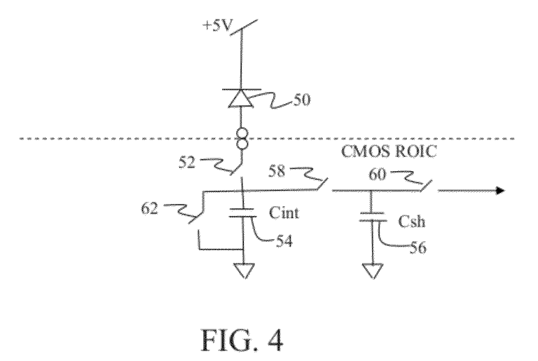

Referring to FIG. 1, the integration time “servo” operation is implemented by performing a real-time frame mean calculation and subsequent control of the integration time by sending the read out integrated circuit (ROIC) for the focal plane array a serial data command for the corrected integration time. FPA 10 provides raw image data 12 to a field programmable gate array (FPGA) 13. As one of its functions, the FPGA provides a frame mean calculation 14 based on all pixels in the data from the FPA which results in an output of a frame spatial mean 16. The integration time servo 18 receives the frame spatial mean and a target mean 20 set by user input and supplies a new Tint 22 through a serial command generator 24 as serial command data 26 to the FPA controlling charge time from the detector diode in each pixel to the integration capacitor for each pixel unit cell. An exemplary target mean is determined based on 80% of the charge well capacity for the detector diodes. Tint is calculated in the integration time servo based on the difference between the frame spatial mean and target mean The Tint servo may employ various algorithms for smoothing of the Tint value transition to limit oscillation and provide system damping. An exemplary unit cell for the detector diode in the FPA is shown in FIG. 4. Diode 50 is read into the ROIC through integrating switch 52 to the integrating capacitor, Cint, 54. A parallel sample and hold capacitor, Csh, 56 with sample switch 58 to read from the integrating capacitor is provided for this embodiment with a read switch 60 for output of the data. An integration capacitor reset switch 62 resets Cint between samples. Control of integrating switch 52 is accomplished using Tint for maximizing well fill on diode 50.

Operation of the detector elements in the FPA at near charge well capacity takes advantage of more of the dynamic range (DR) of the detector, which is approximately 14,000:1, providing far greater resolution capability over the normal dynamic range associated with imaging resolution at any given Tint, DR≈3000:1. This allows a far improved signal to noise ratio (SNR) for low flux conditions.

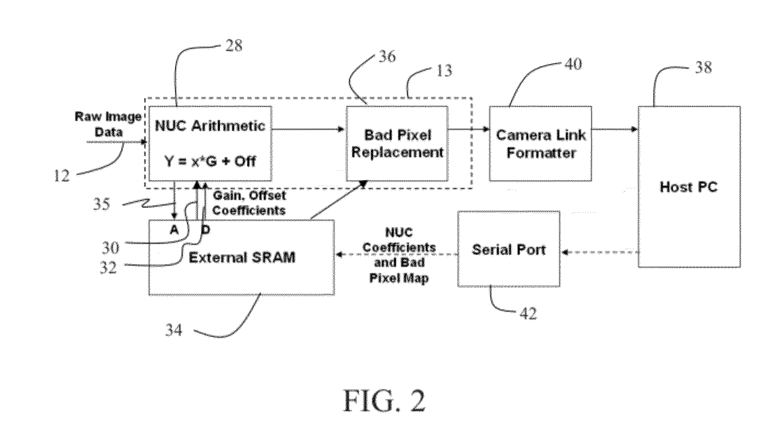

Nonuniformity correction (NUC) is applied to the resulting image data using a simple “two point” correction scheme as shown in FIG. 2. The raw image data 12 from the FPA is routed through a NUC arithmetic unit 28 within the field programmable gate array (FPGA) on the camera electronics board that applies gain and offset corrections in pipeline fashion to produce grey-level corrected pixel values. The gain (G) 30 and offset (Off) 32 correction values are provided from an external memory, in the embodiment shown SRAM 34, addressed 35 in response to the actual well fill value for each pixel detector.

A very small number of nonuniformity correction (NUC) tables are required to spatially correct the scene over a very wide range of operational integration times when operating in this dynamically adjusted Tint mode. The requirement for nonuniformity correction is dependent on the well fill in the detectors. By dynamically controlling the well fill to a nominal fixed value, approximately 80% as in the exemplary embodiment, the variation about the nominal well fill is reduced thereby allowing common use of NUC tables. Without dynamic control of Tint in prior art systems greater variation of the actual well fill in the detectors required a larger number of NUC tables to correct for the range of variation.

Following NUC, a bad pixel replacement operation 36 is performed with stored data of spatial locations of bad pixels within the frame. For an exemplary embodiment, simple replacement logic is implemented that replaces a known bad pixel with a neighboring pixel value. The image data is then presented to a host personal computer 38 via a Camera Link digital data interface 40. A Camera Link frame grabber within the host PC collects the frame of image data and displays it to the user. Values for the Gain and offset are pre-computed off-line and written at system startup from the host PC through a serial port 42 into the memory (SRAM) 34 on the camera board electronics. Similarly, bad pixel identification on the FPA is performed off line by the Host PC and that data with the substitute pixel location is provided through the serial port to the SRAM. These operations are indicated in the diagram with dashed lines.

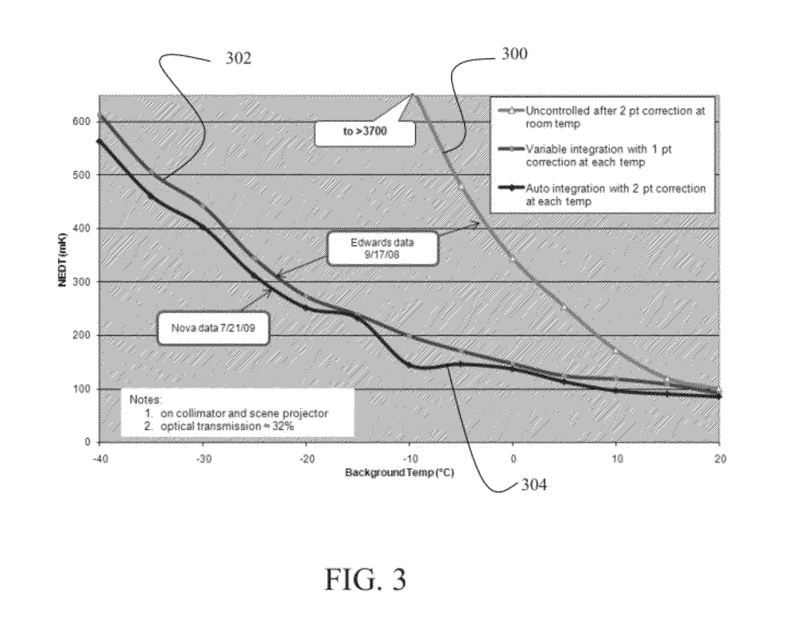

FIG. 3 shows the results of tests with the camera operating in conventional fixed integration time mode (red line 300, 1.0 ms Tint) and in a hand adjusted 80% well fill mode (blue line 302). It was the dramatic increase in noise (and subsequent NEDT value) at low background scene temperatures that prompted investigation of how a conventional MWIR FLIR camera system could be operated so as to improve its performance.

By pinning the average well fill condition to approximately 80%, a dramatic improvement in noise equivalent delta temperature (NEDT) over a very wide range of scene background temperatures can be achieved. Because the FPA that was used for these tests incorporated a direct injection (DI) input stage in its ROIC and because the charge injection efficiency of this device suffers in low photocurrent conditions, the resulting signal to noise ratio (SNR) of the FPA is also poor at low scene backgrounds. The dark blue line 304 of FIG. 3 for an exemplary embodiment as described provides further improved results by a small, but consistent margin. The overall NEDT values produced were high as compared to conventional camera systems; 100 mK is approximately 5× higher than a conventional camera system, driven mainly by the increased flux produced by the warm collimating optics of the scene generator. The length of time to collect this data was dominated by the thermal settling time of the Santa Barbara Infrared scene generator; it took the scene generator approximately 20 to 30 minutes to settle in response to a 5° C. commanded change.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An infrared camera system comprising:
a focal plane array (FPA) of a plurality of detector diodes;
a read out integrated circuit (ROIC) including a plurality of integration switches connected to the plurality of detector diodes;
a frame mean calculator receiving raw data from the FPA;
an integration time servo receiving a frame mean from the frame mean calculator and a preprogrammed target mean, said integration time servo comparing the frame mean and target mean and providing an integration time output to the ROIC responsive to the comparison for control of the integration switches.

2. An infrared camera system as defined in claim 1 further comprising a nonuniformity correction arithmetic unit receiving raw data from the FPA.

3. An infrared camera system as defined in claim 1 further comprising a bad pixel replacement unit.

4. An infrared camera system as defined in claim 2 further comprising a memory storing predetermined nonuniformity correction tables, said memory addressed by the nonuniformity correction arithmetic unit based on raw data from the FPA and providing selected ones of said nonuniformity correction tables to the nonuniformity correction arithmetic unit responsive to said address.

5. An infrared camera system as defined in claim 4 wherein the nonuniformity correction tables are stored in the memory by a host computer prior to operation of the camera system.

6. A method for operation of an infrared camera system comprising:
reading data from a focal plane array of a plurality of detectors;
calculating a frame mean;
comparing the frame mean to a target mean; and,
adjusting an integration time for the plurality of detectors responsive to the comparison.

7. The method for operation of an infrared camera system as defined in claim 6 further comprising applying nonuniformity correction to the raw data.

8. The method for operation of an infrared camera system as defined in claim 7 wherein the nonuniformity correction is determined based on the FPA data.

9. The method for operation of an infrared camera system as defined in claim 8 wherein the nonuniformity correction is applied by
addressing a memory based on FPA data and
reading a nonuniformity correction table into an arithmetic correction unit from the memory based on the address.
